(19) United States
(12) Patent Application Publication
(10) Pub. No.: US 2006/0031010 A1
(43) Pub. Date: Feb. 9, 2006

(54) Method for one handed controlling of a digital map by use of a keyboard

(76) Inventor: Antje Friedrich, Berlin (DE)

Correspondence Address: SQUIRE, SANDERS & DEMPSEY L.L.P, 600 HANSEN WAY, PALO ALTO, CA, 94304-1043, US

(21) Appl. No.: 10/912,760

(22) Filed: Aug. 4, 2004

(51) Int. Cl. G01C 21/30

(52) U.S. Cl. 701/211; 340/995.14; 340/995.16

(57) ABSTRACT

The method according to the invention enables the single-handed enlargement, reduction, and navigation on a map which is displayed on a display screen of a mobile terminal. To this end, the display screen is subdivided into n segments, preferably in a contiguous manner, according to the spatial arrangement of n keys on the keypad. In this case, the position of a segment on the screen corresponds to the position of the key on the keypad. Depending on the mode selected, the operation of a key results in a corresponding new view of the map.

### FIELD OF THE INVENTION

The invention relates to a method for controlling the view of an image and particularly for controlling the view of a geographic map displayed on a mobile terminal.

### BACKGROUND OF THE INVENTION

With the increasing capability of mobile terminals, in particular personal digital assistants (PDAs) and telephones, tasks which were previously reserved for highly complex systems are increasingly transferred to these devices. One example of this is the representation of, and interaction with, digital map material and location-related data for the purpose of information and navigation. To make this possible on any mobile terminal, a standard interface is required.

The control by means of a joystick or corresponding arrow keys is decidedly laborious and not subject to any standard.

If special input means are not present, one is confronted with a further problem with regard to how an interactive map can be operated with one hand if a suitable input device, such as a touch screen, mouse or tracking ball is not present.

### SUMMARY OF THE INVENTION

An object of the invention is to mitigate or obviate these problems associated with conventional interfaces for such interactive digital images or displays. A further object of the invention is to provide a method which enables simple navigation on a mobile terminal which has a limited number of keys and includes a display.

A method according to the present invention enables single-handed enlargement of, and navigation on, a digital image such as a map. To this end, a display screen is subdivided into n segments, preferably in a contiguous manner, according to the spatial arrangement of n keys on the keypad. In this case, the position of a segment on the screen corresponds to the position of a key on the keypad.

Depending on the selected mode, the operation of a key leads to a corresponding new view of the map.

According to one embodiment of the present invention, the view of the map is divided into nine segments, whereby the nine segments are assigned to nine corresponding keys that are uniquely identified, for example, with the digits “1” to “9” on the mobile terminal or telephone. It should hereby be taken into consideration that the segmentation does not have to be displayed permanently, but only when desired if, for example, a key is pressed for the first time.

According to another embodiment of the present invention, the view of the map is, for example, controlled in such a manner that, by pressing or actuating a key, one zooms into a segment of the map to which is assigned the corresponding key resulting in enlargement of that portion of the image. Alternative controls are also feasible. Thus, for example, depressing a key can also produce a zooming out, resulting in reduction of the image. In a further preferred embodiment, pressing a key which is not assigned to any segment, for example, a C-key or 0-key, results in zooming out.

The type of control is determined by the duration of the actuation or the frequency of the actuation, whereby a long actuation (key depression) controls the zoom function or a short actuation can effect a shift of the map section or the speed of the zoom process or a rapid depression can change the zoom centre or control the direction of the zoom process.

According to a further embodiment of the present invention software is provided for a mobile terminal, in particular a cellular (mobile) telephone or PDA, which implements the described functionality of the method. In this case, the data structure or the software, for example an on-line loadable program, is written in such a way that it can be simply converted, for example compiled or interpreted, on various devices into an easy-to-run program. Preferably, this is obtained by using program languages which are available for a plurality of platforms, e.g. C, C++, C# Java program. Other programming languages are also feasible. The invention includes a data carrier having a program structure that realizes the described functionality after it has been loaded onto the mobile terminal.

According to yet another embodiment of the present invention there is provided a mobile terminal, in particular a cellular (mobile) telephone or a PDA, which is equipped such that the method according to the invention can be carried out.

According to one aspect of the present invention, there is provided a method for controlling a view of a geographic map displayed on a mobile terminal, the mobile terminal having n keys and a screen display for viewing the geographic map, the method comprising (a) subdividing the view of the geographic map into n segments which can be recognized optically at least temporarily, (b) assigning the n keys of the mobile terminal uniquely to the n segments of the geographic map, and (c) controllling the view of the geographic map by pressing any one of the assigned n keys.

According to a further aspect of the present invention, there is provided a data carrier having a data structure, the data structure for loading on a mobile terminal having n keys and a display screen for viewing a geographic map, the data structure comprising (a) subdividing means for subdividing a view of the geographic map into n segments which can be recognized optically at least temporarily, (b) assignment means for assigning the n keys of the mobile terminal uniquely to the n segments of the geographic map, and (c) control means for controlling the view of the geographic map by pressing any one of the assigned n keys.

According to another aspect of the present invention, there is provided a mobile terminal comprising (a) n keys, (b) a display screen for viewing a geographic map, (c) means for subdividing a view of the geographic map into n segments which can be recognized optically at least temporarily, (d) means for assigning the n keys of the mobile terminal uniquely to the n segments of the geographic map, and (e) means for controlling the view of the geographic map by pressing any one of the assigned n keys.

### BRIEF DESCRIPTION OF THE DRAWINGS

The invention will be described in greater detail in the following with reference to embodiments which are schematically illustrated in the drawings. The same reference numbers in the individual drawings thereby designate the same elements. In particular:

FIG. 1 illustrates a mobile terminal which shows a geographic map that is divided into segments; and

FIG. 2 illustrates the mobile terminal from FIG. 1 in which the keypad can be seen.

### DETAILED DESCRIPTION OF THE INVENTION

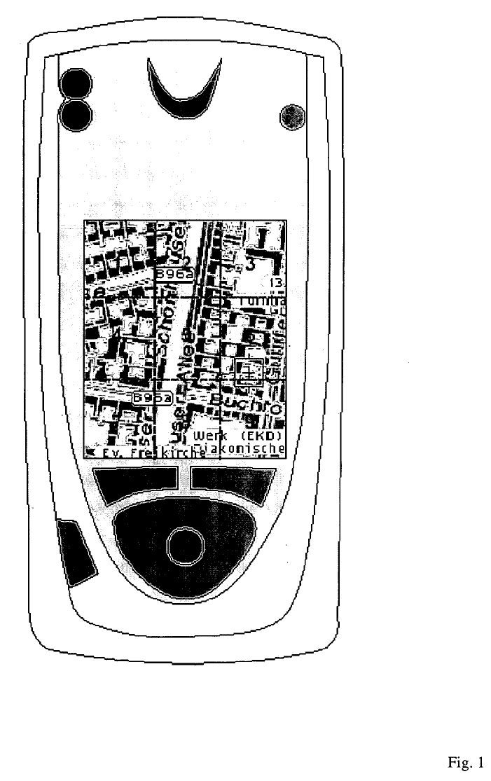

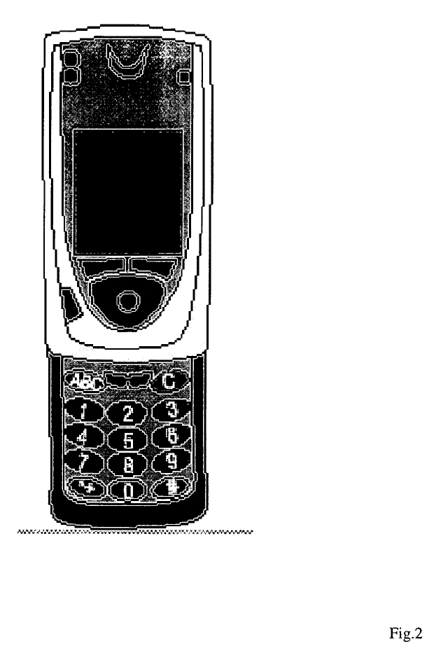

With reference to a mobile terminal having a 10-key pad, FIG. 1 and FIG. 2 show the division of the map into nine segments. The position of each segment corresponds to a respective key (1-9) on a keypad of the mobile terminal (for example a mobile telephone or a PDA).

According to an embodiment of the present invention, an enlargement and reduction of a section can be carried out, for example, as follows:

a) Selective Enlargement (Zoom In)

In the zoom mode, by pressing a key, the section of the image (such as a map) which corresponds spatially with the key is enlarged, the centre of the selected map section is displayed in the centre of the screen after the enlargement process has been completed and, at the same time, the section has been enlarged. This process can be repeated again and again, for example, automatically by continued pressing of the key, or manually by repeated pressing.

b) Selective Reduction (Zoom Out)

By operating a key which is not allocated to any segment of the screen (for example in the case of a 10-key pad, the key “0”), the user can zoom out of the map with one hand and in freely selectable steps. Preferably, there are two options for this:

aa) In this process, the centre of the map remains unchanged.

bb) In this process, the zooming out takes place in reverse sequence of the zooming in.

If a prior zooming into the map did not take place, then option aa) automatically comes into effect.

The foregoing description of the preferred embodiments of the present invention has been presented for the purposes of illustration and description. It is not intended to be exhaustive or to limit the application. Many modifications, variations and adaptations are possible without departing from the scope of the invention as defined in the claims.

I claim:

1. A method for controlling a view of a geographic map displayed on a mobile terminal, the mobile terminal having n keys and a screen display for viewing the geographic map, the method comprising:
subdividing the view of the geographic map into n segments which can be recognized optically at least temporarily;
assigning the n keys of the mobile terminal to the n segments of the geographic map; and
controlling the view of the segments by pressing any one of the assigned n keys.

2. The method according to claim 1, wherein the arrangement of the segments corresponds to the spatial arrangement of the keys.

3. The method according to claim 1, wherein the map is segmented in a contiguous manner.

4. The method according to claim 1, wherein the n segments comprise nine segments and wherein the nine segments are each assigned to one of nine number keys of the mobile terminal.

5. The method according to claim 1, wherein the view of the map is controlled in such a manner that when one of the n keys is pressed the segment which is assigned to the key is enlarged (zoom in).

6. The method according to claim 1, wherein the view of the map is controlled in such a manner that when a key which is not assigned to any segment is pressed a previously enlarged segment is reduced (zoom out).

7. The method according to claim 6, wherein the key which is not assigned to any segment is a C-key or a 0-key.

8. The method according to claim 1, wherein the type of control is determined by the duration and/or the frequency of the pressing.

9. The method according to claim 8, wherein long pressing controls a zoom function and/or short-time pressing effects a shift of the section of the map and/or the speed of the zoom process and/or rapid pressing can change the zoom centre and/or control a direction of the zoom process.

10. A data carrier having a data structure, the data structure for loading on a mobile terminal having n keys and a display screen for viewing a geographic map, the data structure comprising:
subdividing means for subdividing a view of the geographic map into n segments which can be recognized optically at least temporarily;
assignment means for assigning the n keys of the mobile terminal to the n segments of the geographic map; and
control means for controlling the view of the segments by pressing any one of the assigned n keys.

11. The data carrier according to claim 10, wherein the mobile terminal is a mobile telephone.

12. The data carrier according to claim 10, wherein the mobile terminal is a personal digital assistant (PDA)

13. The data carrier according to claim 10, wherein the data structure is an on-line loadable program.

14. The data carrier according to claim 13, wherein the on-line loadable program is written in C, C++ and/or Java.

15. A mobile terminal comprising:
n keys;
a display screen for viewing a geographic map;
means for subdividing a view of the geographic map into n segments which can be recognized optically at least temporarily;
means for assigning the n keys of the mobile terminal to the n segments of the geographic map; and
means for controlling the view of the segments by pressing any one of the assigned n keys.

16. The mobile terminal according to claim 15, wherein the mobile terminal is a mobile telephone.

17. The mobile terminal according to claim 15, wherein the mobile terminal is a personal digital assistant (PDA).
